(19) United States
(12) Patent Application Publication
(10) Pub. No.: US 2017/0169187 A1
(43) Pub. Date: Jun. 15, 2017

(54) STICK PACK PACKAGING WITH INTEGRATED CIRCUIT

(71) Applicant: Unither Pharmaceuticals, Paris (FR)

(72) Inventors: Michael Valenti, Rochester, NY (US); Hanumantharao Tatapudy, Suffern, NY (US); John Bordeau, Lima, NY (US); Kevin Haehl, Pittsford, NY (US)

(21) Appl. No.: 15/359,258

(22) Filed: Nov. 22, 2016

Related U.S. Application Data
(60) Provisional application No. 62/259,800, filed on Nov. 25, 2015.

(51) Int. Cl. G06F 19/00; B65D 75/58; A61J 1/03; B65D 79/00; A61J 7/04; B65D 75/06; B65D 65/40

(52) U.S. Cl. CPC G06F 19/3462; B65D 75/06; B65D 75/5811; B65D 65/40; B65D 79/00; A61J 7/04; A61J 1/03; A61J 2205/60

(57) ABSTRACT

A stick pack having a top sealed portion with a top edge, a horizontal notch parallel with the top edge and passing through the stick pack, and further including a horizontal perforation line parallel with the top edge. The stick pack also has a bottom edge portion with a bottom sealed edge, a longitudinal seal extending from the top sealed edge to the bottom edge; an integrated RLC circuit; and a spout formed at least partially in the top sealed portion but not extending past the top sealed edge. The stick pack is configured to be folded along its longitudinal axis to fold the notch, and only when the notch is folded can a user easily tear the top sealed edge along the horizontal perforation line to expose the spout.

### CROSS REFERENCE TO RELATED APPLICATIONS

This application claims the benefit of U.S. Provisional Patent Application Ser. No. 62/259,800, filed on Nov. 25, 2015 and entitled “Stick Pack Packing With Integrated Circuit”, the entire disclosure of which is incorporated herein by reference.

### FIELD OF THE INVENTION

The present disclosure is directed to a stick pack pouch or packaging that can be individually identified and tracked using an integrated circuit.

### BACKGROUND

Stick packs, also called stickpacks, stick pack pouches, uni-sticks, and sachets, are long, flexible pouches used to hold a single-serving or single-dose amount of liquid and/or powder. Shaped like a traditional pack of gum, stick packs are sealed on their two short ends and have a single seal down the back. Stick packs are used to hold a variety of food-based compounds, including single-serve drink mixes, real and artificial sweeteners. Stick packs are also used to hold pharmaceutical agents for both adults and children, including in liquid or powder form. The convenient size and shape minimizes packaging and alleviates problems that can arise when users are forced to measure out a dose of a pharmaceutical agent. Rather than requiring a separate dispenser or measuring device, stick packs are quickly opened by the user and the proper dosage is immediately ready for consumption. The stick packs are often opened by ripping the packaging along a factory-scored perforation. However, these perforations are often inadequately or incorrectly scored, or can otherwise be difficult to open.

One of the challenges of administering a medication or other pharmaceutical is tracking whether and when the pharmaceutical was administered to the individual. For elderly individuals that live alone, for example, the timely and proper administration of medications is absolutely necessary. However, the elderly population often has the most difficult time tracking medications. For example, an individual can forget to take a medication, or can take the wrong medication. Further, an individual can take the wrong dosage of a medication. Additionally, an individual can forget that they already took a medication. It can also be difficult to administer and track medications and other pharmaceuticals in a clinical setting. While there are mechanisms and devices to facilitate pharmaceutical and medication tracking, these mechanisms and devices are expensive or onerous.

Accordingly, there is a continued need in the art for passive, easy to use devices that facilitate tracking of pharmaceutical use by an individual.

### SUMMARY OF THE INVENTION

The present disclosure is directed to stick pack packaging and methods of manufacture. According to embodiments described or otherwise envisioned herein, the methods and systems are directed to a stick pack with an upper sealed edge, a lower sealed edge, and a longitudinal edge. The upper region has a notch and a horizontal perforation line parallel with the top edge, and a spout formed at least partially in the upper region but not extending past the upper sealed edge. The stick pack is configured to be folded along its longitudinal axis to fold the notch, and when the notch is folded a user can easily tear the top sealed edge along the horizontal perforation line to expose the spout. The stick pack includes one or more multilayer passive circuits within the laminate that can be detected by an external reader. An administration circuit is broken when the user exposes the spout, and can be utilized to determine whether a stick pack has been opened. An identity circuit can be utilized to determine the identity of a stick pack.

According to an aspect is a stick pack design. The stick pack includes: (i) a top sealed portion with a top edge, a horizontal notch parallel with the top edge and passing through the stick pack, and further having a horizontal perforation line parallel with the top edge; (ii) a bottom sealed edge; (iii) a longitudinal seal extending from the top sealed edge to the bottom edge; (iv) a spout formed at least partially in the top sealed portion but not extending past the top sealed edge; and (v) an integrated RLC circuit; (vi) the stick pack is configured to be folded along its longitudinal axis to fold the notch, such that only when the notch is folded can a user easily tear the top sealed edge along the horizontal perforation line to expose the spout.

According to an embodiment, the integrated RLC circuit comprises: a first layer comprising an inductor coil and a first plate of a capacitor of the RLC circuit; a second layer comprising a dielectric material for the capacitor; and a third layer comprising an inductor coil and a second plate of the capacitor. According to an embodiment, the second layer comprises an opening for electrical communication between the first layer and the second layer.

According to an embodiment, at least a portion of an inductor coil of the RLC circuit extends into the top sealed portion such that the portion of the inductor coil is removed when the user tears the top sealed edge along the horizontal perforation line to expose the spout.

According to an embodiment, the integrated RLC circuit is integrated into one or more internal layers of a laminate material.

According to an embodiment, the stick pack has a first integrated RLC circuit configured to identify the stick pack, and further comprising a second integrated RLC circuit configured to monitor whether the stick pack has been opened.

According to an embodiment, the horizontal perforation line can be intermittent.

According to an aspect is a system for identifying a stick pack. The system includes a stick pack with: (i) a top sealed portion comprising a top edge, a horizontal notch parallel with the top edge and passing through the stick pack, and further comprising a horizontal perforation line parallel with the top edge; (ii) a bottom sealed edge; (iii) a longitudinal seal extending from the top sealed edge to the bottom edge; (iv) a spout formed at least partially in the top sealed portion but not extending past the top sealed edge; and (v) an integrated RLC circuit configured to oscillate at a predetermined frequency. The system further includes a reader device configured to transmit electromagnetic waves at a variety of frequencies, and further configured to detect the predetermined frequency.

According to an embodiment, the system further includes a database comprising a plurality of predetermined frequencies, each predetermined frequency associated with an identity of a stick pack.

According to an aspect is a method for identifying a stick pack. The method includes the steps of: (i) providing a stick pack comprising a passive RCL circuit, where the passive circuit comprises an inductor coil and a capacitor, the RCL circuit oscillating in response to an electromagnetic wave having a predetermined frequency; (ii) transmitting, by an antenna of a reader device, electromagnetic waves of different frequencies; (iii) detecting, by the reader device, a frequency at which impedance of the reader device antenna increases; and (iv) determining, from a database, the identity of the stick pack based on the frequency at which impedance of the reader device antenna increases.

These and other aspects of the invention will be apparent from the embodiments described below.

### BRIEF DESCRIPTION OF THE DRAWINGS

The present invention will be more fully understood and appreciated by reading the Following Detailed description of the invention in conjunction with the accompanying drawings, in which:

FIG. 1 is a schematic representation of a front view and a reverse view of stick pack, in accordance with an embodiment.

FIG. 2 is a schematic representation of a stick pack with a longitudinal axis, in accordance with an embodiment.

FIG. 3 is a schematic representation of a folded stick pack, in accordance with an embodiment.

FIG. 4 is a schematic representation of a stick pack which has been opened to expose the spout, in accordance with an embodiment.

FIG. 5 is a schematic representation of a stick pack prior to folding or sealing, in accordance with an embodiment.

FIG. 6 is a schematic representation of three layers of a stick pack, in accordance with an embodiment.

FIG. 7 is a schematic representation of a stick pack system with an external reader, in accordance with an embodiment.

FIG. 8 is a circuitry schematic of a stick pack external reader, in accordance with an embodiment.

FIG. 9 is a schematic representation of three layers of a stick pack, in accordance with an embodiment.

FIG. 10 is a circuitry schematic of a stick pack system with an external reader, in accordance with an embodiment.

FIG. 11 is a flowchart of a method for detecting a stick pack, in accordance with an embodiment.

### DETAILED DESCRIPTION

The present disclosure describes various embodiments of stick pack packaging. The stick packs include one or more multilayer passive circuits within the laminate that can be detected by an external reader. An administration circuit is broken when the user exposes the spout, and can be utilized to determine whether a stick pack has been opened. An identity circuit can be utilized to determine the identity of a stick pack.

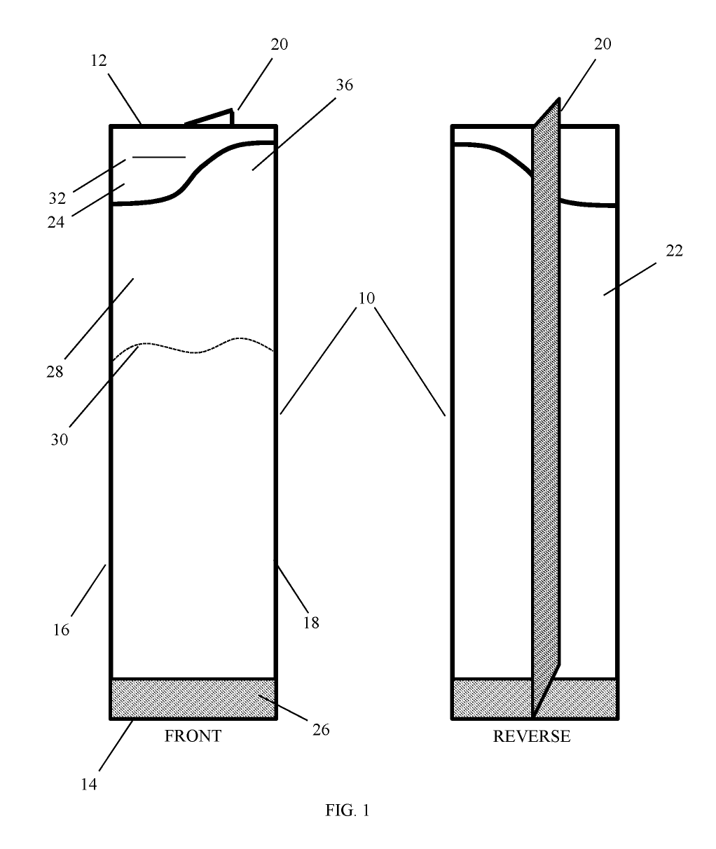

Referring now to the drawings, wherein like reference numerals indicate identical or corresponding parts throughout the several views, there is shown in FIG. 1 a FRONT and REVERSE view of a stick pack 10. Stick pack 10 has top edge 12, bottom edge 14, and side edges 16 and 18. Stick pack 10 also has a sealed edge 20 extending outwardly from the reverse side 22 of the pack, and extending longitudinally along the length of the stick pack.

Stick pack 10 is sealed at three different regions to keep the contents within the closed packaging. The stick pack is sealed at the top region 24, at bottom region 26, and all along sealed edge 20, also called a fin. When the stick pack is filled with a predetermined amount of liquid or powder—shown by dashed fill line 30, although the amount can vary significantly from the shown amount—the contents and the top region seal 24 results in a headspace 28 which contains air or an inert gas. Headspace 28 also prevents spilling or loss of the contents during opening of the stick pack. Headspace 28 allows for resuspension of an oral suspension, such as when the user shakes the stick pack. The headspace also allows mixing or kneading of the stick pack for gels and solutions, including but not limited to thixotropic gels and solutions.

When the stick pack is filled with a predetermined amount of liquid or powder—shown by dashed fill line 30, although the amount can vary significantly from the shown amount—the contents and the top region seal 24 results in a headspace 28 which contains air or an inert gas. For some pharmaceutical products, for example, an inert gas can help prevent oxidation or degradation of the product. Inert gasses can include, for example, nitrogen and/or argon, among others.

According to an embodiment, the stick pack contains variable amounts of the contents. A stick pack containing a liquid or gel can comprise, for example, anywhere from 1 ml to 20 mls of liquid or gel, or more. For example, the size of the stick pack 10 can vary depending on the amount of liquid, gel, or powder intended to be stored inside the packaging. Accordingly, smaller stick packs may comprise less than 1 ml, while larger stick packs may comprise more than 20 mls. Common dosages are 2.5, 5, 10, and 20 mls, among many others.

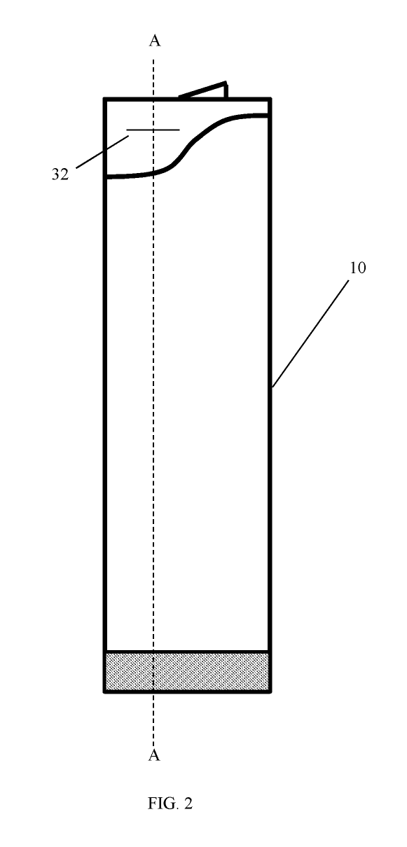

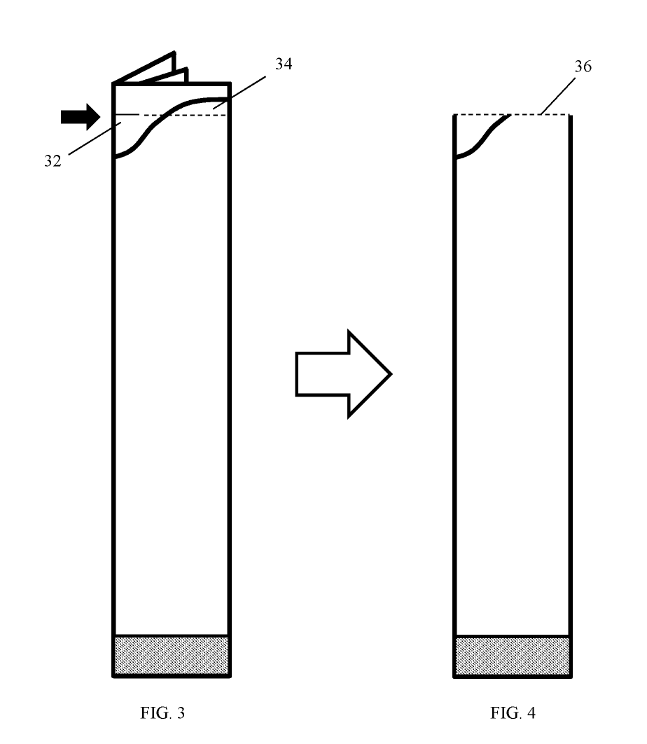

Stick pack 10 can comprise a multi-step child-resistant opening mechanism that balances safety with ease of opening. To open the stick pack 10, a user first folds the stick pack 10 longitudinally along axis A-A, shown in FIG. 2. Folding the stick pack along axis A-A exposes a notch 32, as shown in FIG. 3, which is pre-formed all the way through the stick pack. Prior to folding the stick pack along axis A-A, however notch 32 is inaccessible to the user. When notch 32 is accessible, the user can utilize the notch to rip the top of the stick pack along a pre-scored perforation line 34 to expose the spout 36, as shown in FIG. 4.

According to an embodiment, the scored perforation line 34 is created in the film prior to formation of the stick pack, or before sealing of any of the edges. The perforation line 34 can be formed, for example, by laser ablation of only the outermost layer of the stick pack, by mechanical knife, or by other methods. According to an embodiment, therefore, perforation line 34 is formed by laser ablation of an outermost aluminum layer of a multi-layer film laminate. A laser-scored perforation line 34 allows for thicker films for the stick pack 10 without significantly increasing the force required to tear along the perforation and open the stick pack. Additionally, according to an embodiment the perforation is formed along both sides of fin 20, which allows the user to easily rip through the fin when opening the stick pack.

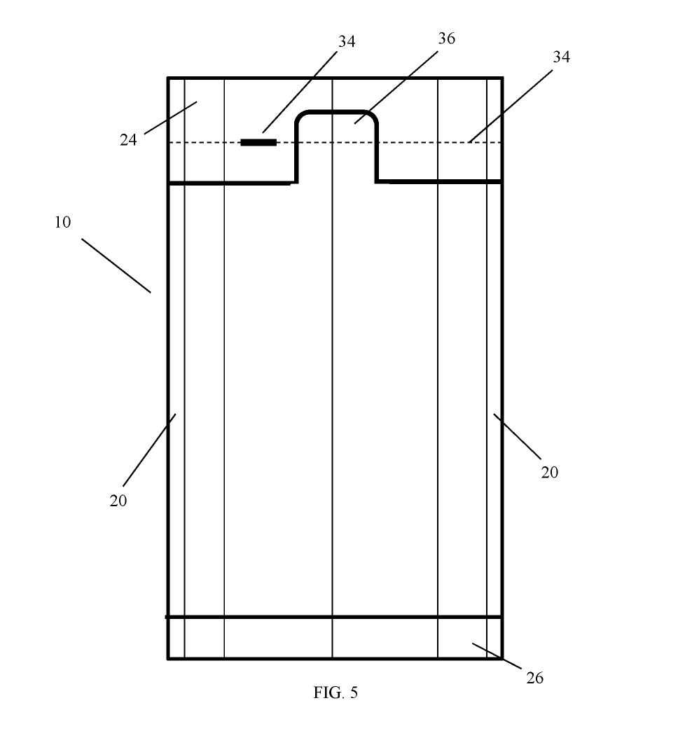

Referring to FIG. 5, in one embodiment, is a stick pack 10 prior to sealing at the top region 24, at bottom region 26, and along sealed edge 20. The stick pack is approximately rectangular and can be cut or punched out of a larger piece of material during manufacturing. To form the stick pack, the two sides of longitudinal seal 20 are placed next to each other and sealed to form a single fin 20. Top region 24 can be sealed, except for the spout region 36, and bottom region 26 can be sealed. Sealing can be accomplished, for example, by heating the region to be sealed. At a point during the manufacturing and/or sealing process, the stick pack 10 is scored and notch 34 is formed.

Stick pack 10 can be made of any suitable material, and can comprise one or a plurality of layers. For example, the innermost layer of the stick pack is preferably made of a material that does not interact with the contents of the stick pack, and does not absorb or otherwise let the contents stick to or diffuse through the material. Examples of suitable layer materials include paper, aluminum, polyethylene (PE), and polyethylene terephthalate (PET), among many others. According to one embodiment, the outermost layer of the stick pack is a paper or aluminum layer upon which logos, instructions, and other labeling materials can be printed. The next layer may be a PET layer, and the innermost layer may be a PE layer. Accordingly, the layers may be aluminum/adhesive/PET/adhesive/PE, in one embodiment.

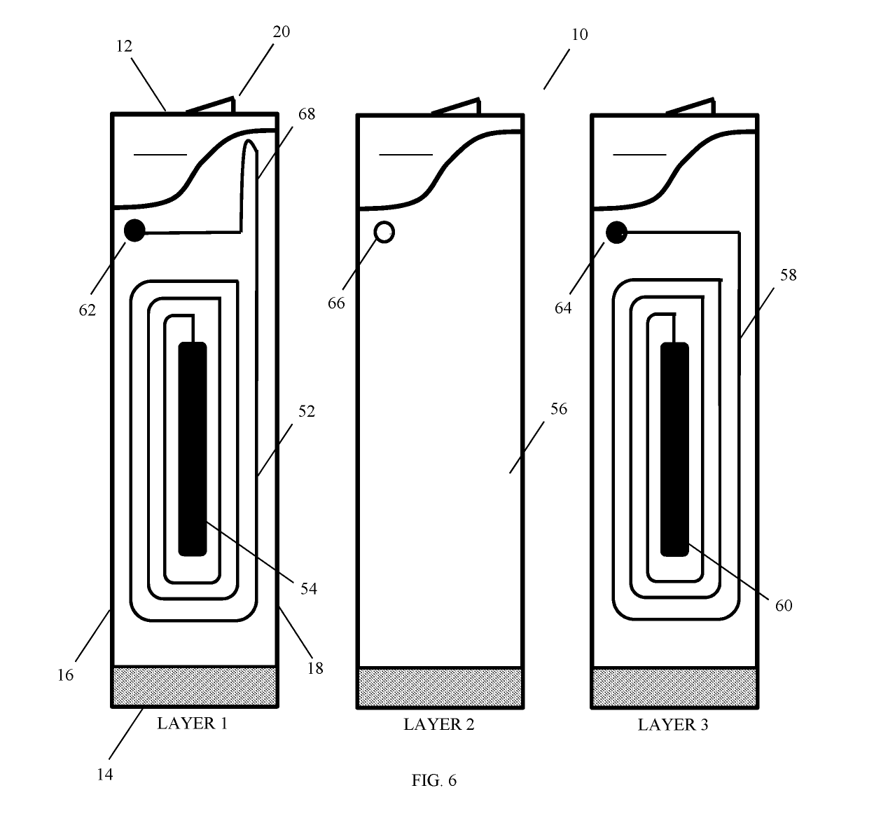

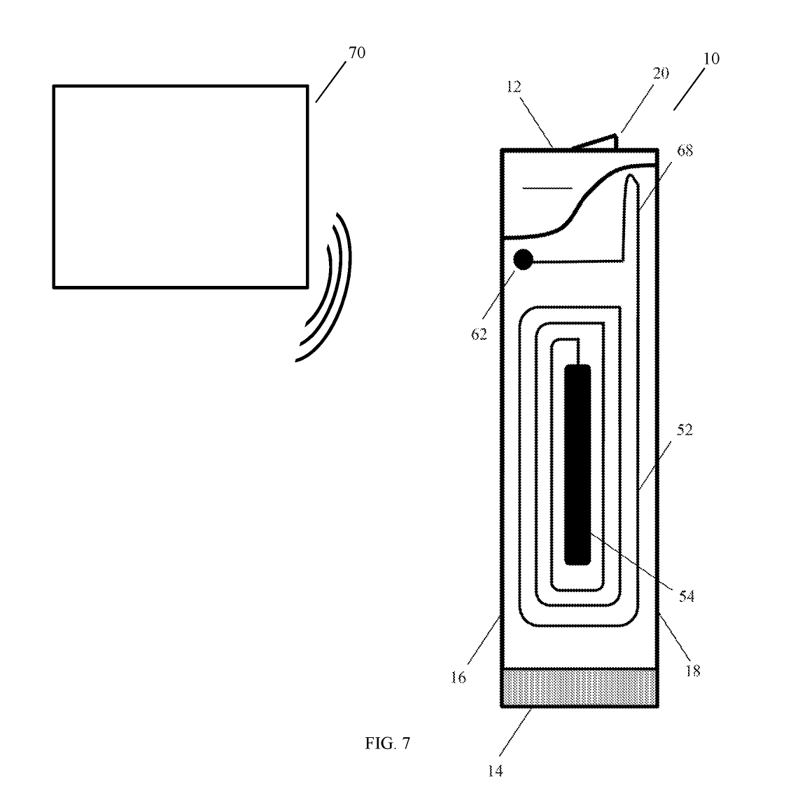

Referring to FIG. 6, in accordance with an embodiment, is a view of multiple layers of stick pack 10. The stick pack has a top edge 12, bottom edge 14, and side edges 16 and 18. Stick pack 10 also has a sealed edge 20 extending outwardly from the reverse side 22 of the pack, and extending longitudinally along the length of the stick pack. Stick pack 10 is sealed at top region 24, bottom region 26, and sealed edge 20. According to an embodiment, stick pack 10 comprises a circuit designed in the film or foil laminate to allow for communication with an external reader. The circuit can be, for example, a passive resistive, inductive, and capacitive (“RLC”) circuit. The RLC circuit inside the film of the stick pack can consists of an inductor such as a coil, a capacitor, and a resistor. These components form an RLC circuit which has an inherent oscillating frequency when the passive circuit is activated. The oscillating frequency is determined by the design of the circuit and can be adjusted or pre-set so that each circuit, and therefore each stick pack, has an individual oscillating frequency. For example, the frequency can be adjusted by changing the geometric design of the pattern(s) that creates the circuit. According to an embodiment, the system will detect the stick pack's presence near a reader, as well as whether a stick pack has been administered. Accordingly, the passive circuit doesn't utilize a battery or other powering device or component inside or attached to the stick pack.

According to an embodiment, the passive circuit or circuits can be applied to the film or layers of the stick pack using a conductive and/or insulating ink, which can be pre-printed onto a stick pack prior to filling and sealing. Alternatively, the layers of the stick pack can be patterned to create a stacked passive circuit design. The circuit is preferably not applied, however, to the inside of the innermost layer of the stick pack, in order to avoid contact with the contents of the stick pack.

As shown in FIG. 6, the stick pack circuit comprises three layers labeled Layer 1, Layer 2, and Layer 3. Layer 1 comprises a bottom inductor coil 52, the bottom plate of the capacitor 54, and the resistor within the trace length. Layer 2 comprises an insulating layer 56—also called a dielectric layer—that provides electrical insulation between the conductor traces of Layer 1 and Layer 3, as well as providing the dielectric material for the capacitor. Layer 3 provides the top inductor coil 58, the top plate of the capacitor 60, and the resistor within the trace length. There is an electrical connection between an electrode 62 of Layer 1 and an electrode 64 of Layer 3 via a hole 66 in the insulating Layer 2. Notably, there can be one or more additional layers to the stick pack film, such as an outer protective layer, an innermost layer, and other layers, just to name a few.

According to an embodiment, the circuit depicted in FIG. 6 is an administration circuit that determines whether the stick pack has been opened. The coil 52 of Layer 1 comprises a loop 68 which extends into the spout area such that when the stick pack is opened as described herein, the coil will be torn and the circuit will be broken. Accordingly, the circuit will no longer oscillate. Alternatively, the coil 58 of Layer 3 could comprise the loop, and/or both Layers 1 and 3 could comprise a loop.

Referring to FIG. 7, in one embodiment, the passive circuit of stick pack 10 can be activated by an external reader 70 or other device sufficient to transmit electromagnetic waves with a frequency at or near the activation frequency. For example, most passive circuits are configured to be activated with electromagnetic waves having a radio frequency, meaning in the range extending from around 3 kHz to 300 GHz which includes frequencies used for communications or radar signals. According to an embodiment, the external reader 70 comprises an antenna, which can be a drive coil, which is fed by a voltage controlled oscillator (“VCO”). To detect a nearby stick pack, the oscillator is swept through a range of frequencies that includes the resonant frequencies of the individual stick pack. When the drive coil oscillator frequency transmitted by the external reader 70 is equal to the stick pack circuit's inherent oscillating frequency, the coils will inductively couple and the impedance to the current through the external reader drive coil (antenna) will increase. The corresponding frequency at which the coils inductively couple can be noted and recorded.

Indeed, one of the features of an RLC circuit is that there is a resonance frequency ω₀ at which the circuit will resonate, or oscillate. The resonance frequency of an RLC circuit can be expressed as:

ω₀=1/\sqrt{LC} (Eq. 1)

As the drive coil of an external reader transmits an electromagnetic wave with a range of frequencies, the transmitted frequency will eventually be equal to the resonance frequency of the RLC circuit in the stick pack. At that frequency, the drive coil in the external reader and the inductor coil in the stick pack circuit will inductively couple and the impedance to the current through the drive coil of the external reader will increase. The external reader detects this increase and records the frequency at which it happens. This frequency is associated in a database with a specific individual stick pack, or with a stick pack type.

According to an embodiment, the external reader 70 can be an at-home device, a cell phone, or a portable stick pack carrying case or container, among other devices. For example, the device's reader circuit would communicate with the patient's or the care taker's cell phone via a Bluetooth link. Each stick pack can be recorded to insure that the proper medication was administered, that the medication was dosed at the correct time, and/or that the stick pack was squeezed to remove the contents. According to an embodiment, the system can be portable.

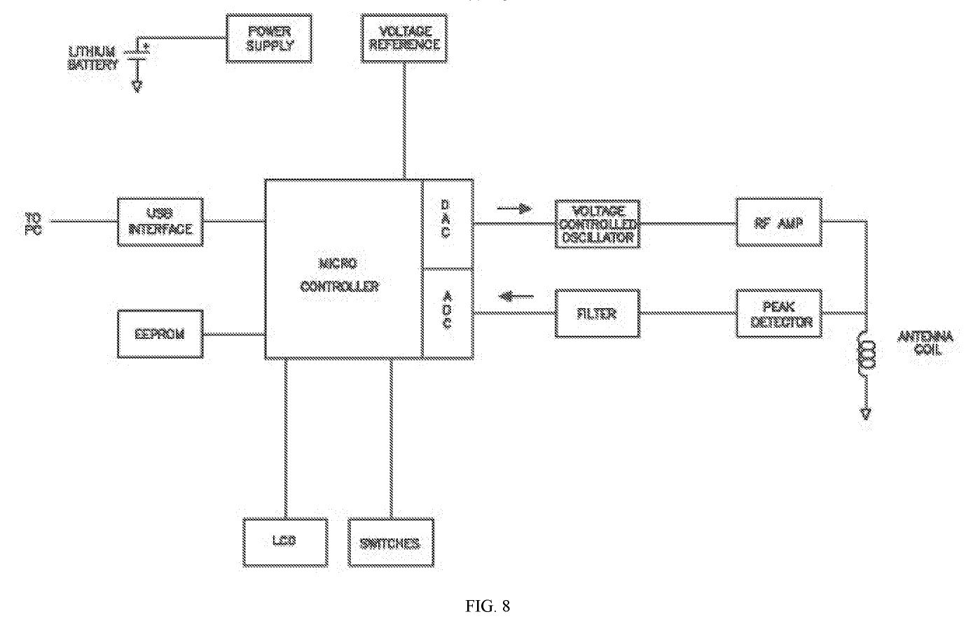

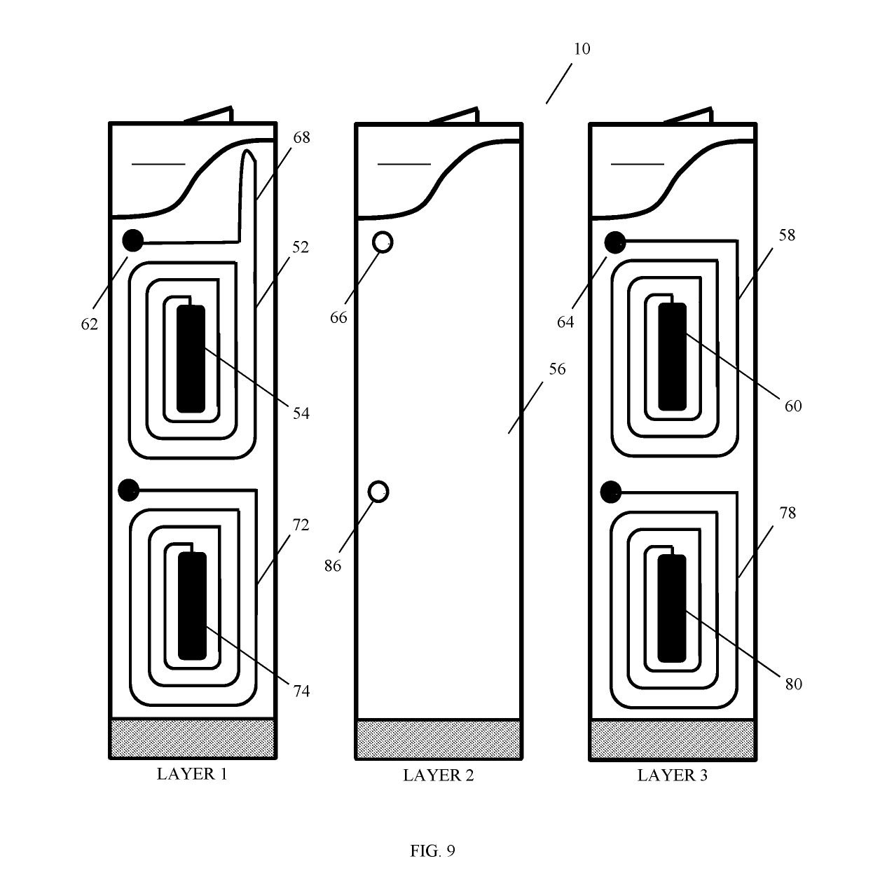

Referring to FIG. 8, in one embodiment, is a schematic for an external reader 70. The external reader uses a voltage controlled oscillator VCO to produce the required signal for the antenna coil, and the VCO is connected to an analog output on the microcontroller. A low power microcontroller with integrated analog to digital converter (ADC) and digital to analog converter (DAC) can be used in the external reader design. The microcontroller can include, for example, sufficient flash memory to hold several hundred readings. An EEPROM can be added to the design to increase memory capability. A voltage reference can be used to decrease the temperature sensitivity of the ADC and DAC. According to an embodiment, the microcontroller is the central processor for the external reader. It reads the switch inputs, updates the display, sweeps the antenna coil frequency and measures and stores the resonant frequency for each circuit detected. The process of finding each circuit's resonant frequency involves searching through a range of frequencies and as such, the microcontroller will be programmed with an efficient search algorithm. Once the resonant frequency is determined, the microcontroller will compute the corresponding circuit for a given resonant frequency. This will be record as the start of the new prescription. The microcontroller also contains a real time clock to keep the current time and date so that a time stamp can be saved along with each reading. According to an embodiment, the microcontroller can communicate with a smartphone or other device using a Bluetooth interface.

Referring to FIG. 9, in one embodiment, is a multi-layer two-circuit stick pack 10. The first, upper circuit is the administration circuit, which monitors whether a stick pack has been opened. The second, lower circuit is an identity or anti-counterfeiting circuit, which specifically identifies the stick pack. The stick pack circuit comprises three layers labeled Layer 1, Layer 2, and Layer 3.

For the administration circuit, Layer 1 comprises a bottom inductor coil 52, the bottom plate of the capacitor 54, and the resistor within the trace length. Layer 2 comprises an insulating layer 56 that provides electrical insulation between the conductor traces between Layer 1 and Layer 3, as well as providing the dielectric material for the capacitor. Layer 3 provides the top inductor coil 58, the top plate of the capacitor 60, and the resistor within the trace length. There is an electrical connection between an electrode 62 of Layer 1 and an electrode 64 of Layer 3 via a hole 66 in the insulating Layer 2. The coil 52 of Layer 1 comprises a loop 68 which extends into the spout area such that when the stick pack is opened as described herein, the coil will be torn and the circuit will be broken. Accordingly, the circuit will no longer oscillate when activated.

For the identity circuit, Layer 1 comprises a bottom inductor coil 72, the bottom plate of the capacitor 74, and the resistor within the trace length. Layer 2 comprises the insulating layer 56 that provides electrical insulation between the conductor traces between Layer 1 and Layer 3, as well as providing the dielectric material for the capacitor. Layer 3 provides the top inductor coil 78, the top plate of the capacitor 80, and the resistor within the trace length. There is an electrical connection between an electrode 62 of Layer 1 and an electrode 64 of Layer 3 via a hole 86 in the insulating Layer 2.

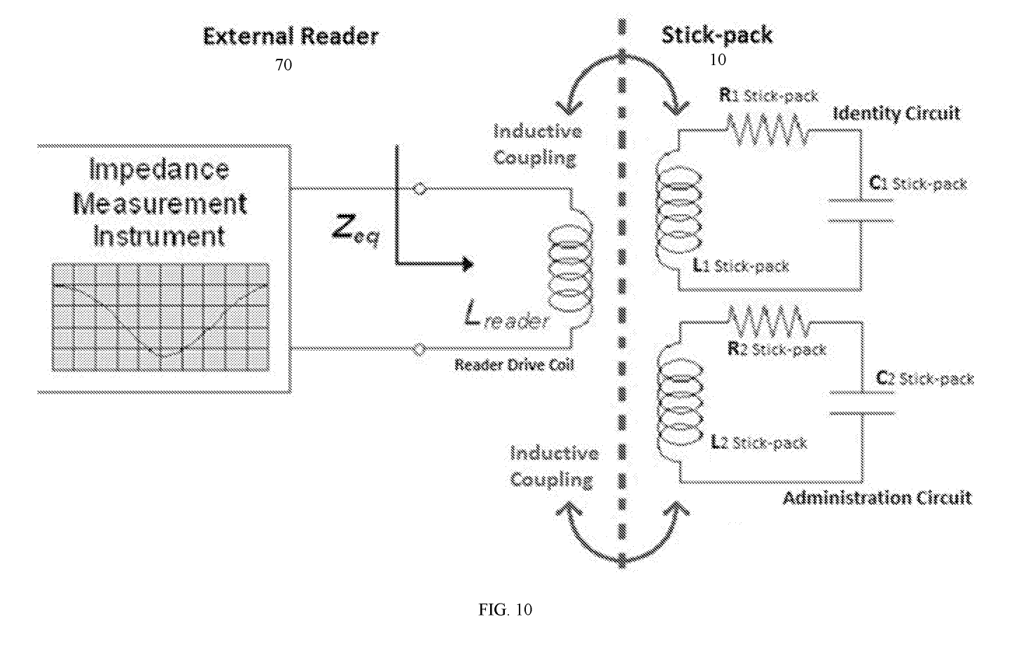

Referring to FIG. 10, in one embodiment, is a circuit diagram for the stick pack 10 depicted in FIG. 8, as well as for external reader 70. Each of the Identity Circuit and the Administration Circuit comprise an inductor coil (L1 and L2), a capacitor (C1 and C2), and a resistor (R1 and R2). The external reader 70 comprises a drive coil that emits an electromagnetic wave to excite the inductor coils of the stick pack circuits, resulting in an oscillation. When the drive coil oscillator frequency transmitted by the external reader 70 is equal to the stick pack circuit's inherent oscillating frequency, the coils will inductively couple and the impedance to the current through the external reader drive coil will increase, and the external reader will identify the transmitted frequency. That transmitted frequency will be associated with the identity of a particular type of stick pack, or with one particular stick pack.

According to an embodiment, stick packs can be sold or stored in a carton or container of multiple stick packs. Each of the stick packs within a carton or container of multiple stick packs will have a unique oscillating frequency to identify the stick pack. Each of the cartons for multiple individual stick packs can have a unique identity circuit with a unique oscillating frequency that identifies each of the individual stick packs within that carton. Each stick pack can also have an administration circuit, each having an oscillating frequency that operates at a frequency different from all of the identity circuits. The administration circuit has a conductor trace that protrudes into the spout area, so that once the stick pack is opened (a tear created in the spout area) the circuit trace is broken and the administration circuit no longer oscillates. Accordingly, the administration circuit is utilized to determine when and/or if the stick pack is administered to the patient. However, the identity circuit will still be operational after administering the medication. With the identity circuit still operational and the administration circuit no longer oscillating, the external reader will record the date and time the medication was taken. Since the identity circuit is still operational even after the medication is taken, the empty disposed stick pack found at the location where dispensed/consumed can be traced back to its original source where dispensed, such as the pharmacy/hospital/home, and the manufacturer can be identified.

According to an embodiment, stick pack 10 can comprise one or more other security features. For example, stick packs can be serialized for tracking and identification. Serializing can comprise, for example, labeling with a unique bar code, QR code, or other code that allows for specific identification of the stick pack. All stick packs can be serialized with a similar code format, while some stick packs may be labeled with a specific code format for an individual manufacturer, date, and/or content. As another security feature, the stick pack can be labeled using a specialty or anti-counterfeiting ink. One or more security features allow for increased tracking and identification of pharmaceuticals. For example, a stick pack sold illegally to another individual can be tracked back to the manufacturer, seller, and/or intended user of the stick pack. Using the bar code, QR code, or other unique code. As another example, suspect stick pack can be authenticated by examining the presence or authenticity of anti-counterfeiting ink or other anti-counterfeiting feature.

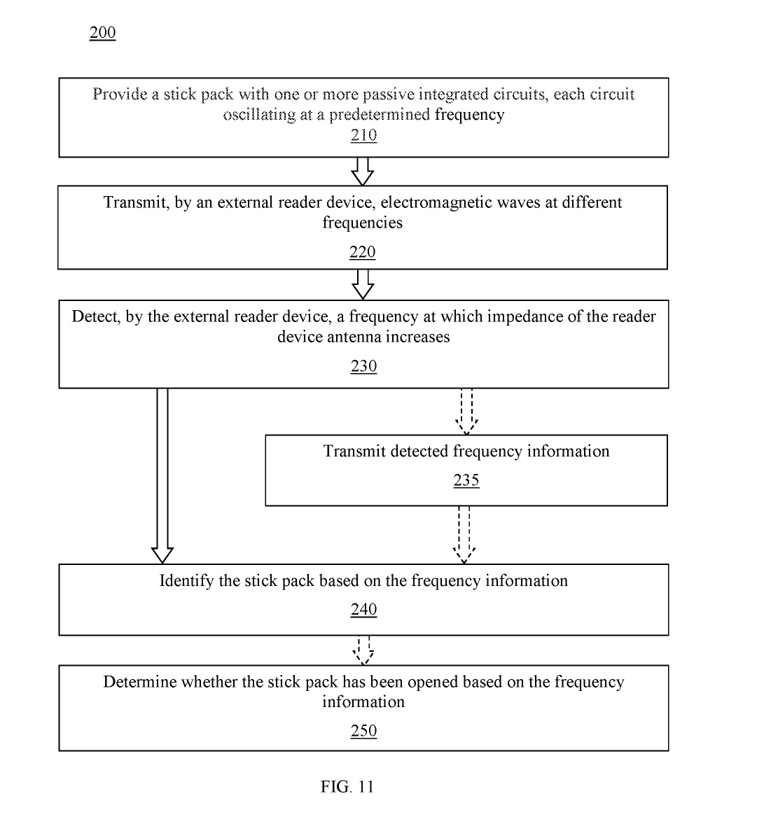

Referring to FIG. 11, in accordance with an embodiment, is a method 200 of characterizing a stick pack. At step 210 of the method, one or more stick packs 10 each with one or more integrated passive circuits is provided. The stick pack 10 can be any of the embodiments described or otherwise envisioned herein. The stick pack may be a single stick pack, a group of stick packs, or a carton of stick packs. The one or more circuits may be an administration circuit and/or an identity circuit. Accordingly, for two or more stick packs, each of the circuits may have a unique oscillation frequency. Each of the oscillation frequencies is associated with a particular stick pack, and the information is stored.

At step 220, an external reader device 70 transmits electromagnetic waves at different frequencies. The external reader device can be any of the devices described or otherwise envisioned herein. For example, the external reader device can comprise a drive coil for transmitting electromagnetic waves. The external reader device can be a stand-alone device, or can be integral with a container, carton, or other storage device. The external reader device can alternatively be associated with a room, storage area, an appliance, or other space. The external reader device can, for example, transmit electromagnetic waves at a wide range of different frequencies to include any possible resonance frequencies. In a system with 100 different possible frequencies at which the stick packs will resonate, the external reader device will test one or more of those possible frequencies.

At step 230, the external reader device detects a change in the impedance of the antenna (drive coil), which means that the drive coil oscillator frequency transmitted by the external reader is equal to the stick pack circuit's inherent oscillating frequency. The coils have inductively coupled and the impedance to the current through the external reader drive coil (antenna) increased. The device notes the frequency at which the impedance changes.

At step 240, the external reader device or a device or computer in communication with the external reader device identifies the stick pack based on the detected frequency. In one embodiment, for example, the external reader device is in wired or wireless communication with another device or with a computer or server, and transmits the detected frequency information to the other device at step 235. The external reader device or other device can identify the stick pack based on the detected frequency by, for example, querying a database of stick packs and associated frequencies.

At optional step 250, the external reader device or a device or computer in communication with the external reader device determines whether the stick pack has been opened based on the detected frequency. For example, at step 240 the stick pack is identified, and based on that identification, there should be a second frequency at which the administration circuit of the stick pack will resonate. If the external reader device fails to detect an impedance change at the frequency of the administration circuit, but the stick pack is present based on an impedance change at the frequency of the identity circuit of the stick pack, then the system concludes that the administration circuit has been disrupted by opening of the stick pack.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A stick pack comprising:
a top sealed portion comprising a top edge, a horizontal notch parallel with the top edge and passing through the stick pack, and further comprising a horizontal perforation line parallel with the top edge;
a bottom sealed edge;
a longitudinal seal extending from the top sealed edge to the bottom edge;
a spout formed at least partially in the top sealed portion but not extending past the top sealed edge; and
an integrated RLC circuit;
wherein the stick pack is configured to be folded along its longitudinal axis to fold the notch, wherein only when the notch is folded can a user easily tear the top sealed edge along the horizontal perforation line to expose the spout.

2. The stick pack of claim 1, wherein the integrated RLC circuit comprises:
a first layer comprising an inductor coil and a first plate of a capacitor of the RLC circuit;
a second layer comprising a dielectric material for the capacitor; and
a third layer comprising an inductor coil and a second plate of the capacitor.

3. The stick pack of claim 2, wherein the second layer comprises an opening for electrical communication between the first layer and the second layer.

4. The stick pack of claim 1, wherein at least a portion of an inductor coil of the RLC circuit extends into the top sealed portion such that the portion of the inductor coil is removed when the user tears the top sealed edge along the horizontal perforation line to expose the spout.

5. The stick pack of claim 1, wherein the integrated RLC circuit is integrated into one or more internal layers of a laminate material.

6. The stick pack of claim 1, comprising a first integrated RLC circuit configured to identify the stick pack, and further comprising a second integrated RLC circuit configured to monitor whether the stick pack has been opened.

7. The stick pack of claim 1, wherein the horizontal perforation line is intermittent.

8. A system for identifying a stick pack, the system comprising:
a stick pack comprising: (i) a top sealed portion comprising a top edge, a horizontal notch parallel with the top edge and passing through the stick pack, and further comprising a horizontal perforation line parallel with the top edge; (ii) a bottom sealed edge; (iii) a longitudinal seal extending from the top sealed edge to the bottom edge; (iv) a spout formed at least partially in the top sealed portion but not extending past the top sealed edge; and (v) an integrated RLC circuit configured to oscillate at a predetermined frequency; and
a reader device configured to transmit electromagnetic waves at a variety of frequencies, and further configured to detect the predetermined frequency.

9. The system of claim 8, wherein the integrated RLC circuit comprises:
a first layer comprising an inductor coil and a first plate of a capacitor of the RLC circuit;
a second layer comprising a dielectric material for the capacitor; and
a third layer comprising an inductor coil and a second plate of the capacitor.

10. The system of claim 9, wherein the second layer comprises an opening for electrical communication between the first layer and the second layer.

11. The system of claim 8, wherein at least a portion of an inductor coil of the RLC circuit extends into the top sealed portion such that the portion of the inductor coil is removed when the user tears the top sealed edge along the horizontal perforation line to expose the spout.

12. The system of claim 8, wherein the integrated RLC circuit is integrated into one or more internal layers of a laminate material.

13. The system of claim 8, comprising a first integrated RLC circuit configured to identify the stick pack, and further comprising a second integrated RLC circuit configured to monitor whether the stick pack has been opened.

14. The system of claim 8, further comprising a database comprising a plurality of predetermined frequencies, each predetermined frequency associated with an identity of a stick pack.

15. The system of claim 8, wherein the horizontal perforation line is intermittent.

16. A method for identifying a stick pack, the method comprising the steps of:
providing a stick pack comprising a passive RCL circuit, wherein the passive circuit comprises an inductor coil and a capacitor, the RCL circuit oscillating in response to an electromagnetic wave having a predetermined frequency;
transmitting, by an antenna of a reader device, electromagnetic waves of different frequencies;
detecting, by the reader device, a frequency at which impedance of the reader device antenna increases; and
determining, from a database, the identity of the stick pack based on the frequency at which impedance of the reader device antenna increases.

17. The method of claim 16, wherein the stick pack further comprises: (i) a top sealed portion comprising a top edge, a horizontal notch parallel with the top edge and passing through the stick pack, and further comprising a horizontal perforation line parallel with the top edge; (ii) a bottom sealed edge; (iii) a longitudinal seal extending from the top sealed edge to the bottom edge; and (iv) a spout formed at least partially in the top sealed portion but not extending past the top sealed edge.

18. The method of claim 16, wherein the integrated RLC circuit comprises:
a first layer comprising an inductor coil and a first plate of a capacitor of the RLC circuit;
a second layer comprising a dielectric material for the capacitor; and
a third layer comprising an inductor coil and a second plate of the capacitor.

19. The method of claim 18, wherein the second layer comprises an opening for electrical communication between the first layer and the second layer.

20. The method of claim 16, wherein at least a portion of an inductor coil of the RLC circuit extends into the top sealed portion such that the portion of the inductor coil is removed when the user tears the top sealed edge along the horizontal perforation line to expose the spout.

21. The method of claim 16, wherein the integrated RLC circuit is integrated into one or more internal layers of a laminate material.

22. The method of claim 16, wherein the stick pack comprises a first integrated RLC circuit configured to identify the stick pack, and further comprising a second integrated RLC circuit configured to monitor whether the stick pack has been opened.

23. The method of claim 16, wherein the horizontal perforation line is intermittent.
